(19) United States
(12) Patent Application Publication
(10) Pub. No.: US 2002/0074274 A1
(43) Pub. Date: Jun. 20, 2002

(54) Bag splitter and wet separator

(76) Inventor: Christopher Peggs, Reading (GB)

Correspondence Address: Richard E. Fichter, BACON & THOMAS, PLLC, 625 Slaters Lane, Alexandria, VA, 22314-1176, US

(21) Appl. No.: 10/022,350

(22) Filed: Dec. 20, 2001

(30) Foreign Application Priority Data
Dec. 20, 2000 (GB) 0031340.3

(51) Int. Cl. B01D 35/00

(52) U.S. Cl. 210/173

(57) ABSTRACT

A bag splitting apparatus for use in splitting open bags containing solid waste having a rotatable flail structure with a plurality of flexible flails attached to a rotatable mounting, the flails being formed from a material having a Young's modulus of less than 50 GN/m²; and a waste feed guide structure capable of receiving bagged solid waste and directing it towards the rotatable flail structure when the apparatus is in use.

This invention relates to apparatus for use in the processing of solid waste, particularly municipal solid waste.

Municipal waste, such as household waste, is generally placed in bags to facilitate collection for disposal. After collection the waste is generally further processed before disposal. For example, municipal waste is often sorted to remove certain types of material for recycling.

Before further processing can take place the waste must be removed from the bags in which it is collected. There is thus a need for an efficient, automated system capable of continuously tearing open bags of municipal solid waste so that the refuse may be removed. With household waste a particular problem is encountered with the occurrence of ‘bags-within-bags’, wherein small quantities of refuse are collected in a smaller bag which is then itself placed inside a standard refuse bag for collection. Bag splitting systems which are capable of tearing open the outer bag often leave inner bags unopened with the result that the refuse is not fully released for processing.

U.S. Pat. No. 5,188,500 describes a bag splitting apparatus comprising a rotating flail structure. In the preferred embodiment of this apparatus the flails are formed of steel wire rope cable and the apparatus relies on the impact force of the flails striking the bags to split the bags open. The disadvantage of this system is that the use of impact force to split open the bags risks damage to the contents of the bags.

The inventors have developed a bag splitting apparatus which is capable of splitting open plastic refuse bags and bags-within-bags whilst minimising the degree of damage to the contents of the bags.

Therefore, in accordance with a first aspect of the invention there is provided a bag splitting apparatus for use in splitting open bags containing solid waste, comprising:

a rotatable flail structure having a plurality of flexible flails attached to a rotatable mounting, the flails being formed from a material having a Young's modulus of less than 50 GN/m²; and

a waste feed guide structure capable of receiving bagged solid waste and directing it towards the rotatable flail structure when the apparatus is in use.

In a preferred embodiment the rotatable flail structure is adapted to rotate at at least 11 ms⁻¹ when the device is in use.

In the apparatus of the invention the flails are made of a material having a Young's modulus of less than 50 GN/m². Preferably the flails are made of a material having a Young's modulus of less than 20 GN/m², even more preferably the flails are made from a material having a Young's modulus of less than 10 GN/m²and most preferably the flails are made from a material having a Young's modulus of less than 5GN/m².

In the present invention it is essential that the flails are formed from a material having a high degree of flexibility (i.e. a relatively low Young's modulus), in marked contrast to the steel wire rope cable flails which are flexible only to a limited extent. Rather than relying on a heavy impact force to split the bags as with flails of steel wire cable, the apparatus of the invention utilises flexible flails made from a material of low stiffness rotating at a relatively high speed of rotation to provide a whip-like cutting action to tear open plastic bags whilst causing minimal damage to the solid contents of the bags. The highly flexible, high speed flails will efficiently tear thin plastic sheets and bags but will not damage tough items such as wood, metal, glass, minerals, rubble, plastic bottles etc.

In a preferred embodiment the flails are formed from a material having low resilience and high flexibility, such as thin strands of a plastic or polymeric fibre material, e.g. plastic strands of small diameter, or rope etc. In a further embodiment the flails may be formed of a resilient but highly flexible material (e.g. bristles). Suitable materials for construction of resilient flails include brush bristles, particularly nylon bristles, thin wire cables etc.

The waste feed guide structure of the apparatus preferably comprises a feed chute of two-part construction having a top chute portion and a bottom chute portion. The bottom chute portion is preferably hinged to the top chute portion to allow independent movement of the bottom chute portion relative to the top chute portion about the hinge. When the apparatus is in use the bottom chute portion directs bagged solid waste introduced into the feed chute towards the rotatable flail structure.

In a preferred embodiment a balance weight is affixed to the bottom chute portion. The balance weight functions to maintain the bottom chute portion at a pre-determined angle to the vertical in the absence of any other deflecting force on the bottom chute portion but allows further deflection of the bottom chute portion when a sufficient deflecting force is applied thereto. Thus, when the apparatus encounters a refuse bag containing a large object the bottom chute portion may be deflected away from the rotatable flail structure, avoiding the problem of large objects becoming jammed between the feed chute and the rotatable flail structure.

The top chute portion preferably has an adjustable back plate which is hinged to the bottom chute portion and capable of independent movement relative to the bottom chute portion about the hinge.

The bag-splitter apparatus of the invention may be used on its own as a means for tearing open bags of solid waste or may be used as a component of a waste processing system which includes means for further processing the waste released by the action of the bag splitter.

It is common to further process waste into a ‘heavy’ fraction, containing large, heavy items such as metal, glass etc, and a ‘light’ fraction comprising paper, textiles, light plastics, wood etc. The present inventors have devised an automated wet separator apparatus for the separation of solid waste, particularly municipal solid waste, into light and heavy fractions. This apparatus may be used on its own or as a component of a larger waste processing system. Advantageously, it may be used in combination with the bag splitter apparatus of the invention.

Therefore, in a further aspect the invention provides a wet separator apparatus adapted for use in separating solid waste according to density comprising:

a separation tank containing a body of liquid;

means for creating a horizontal flow of liquid within the tank such that when solid waste is received in the body of liquid it is separated into a heavy solid waste fraction having a density above a certain threshold and light solid waste fraction having a density below the threshold; and

means for separately removing the heavy and light solid waste fractions from the separation tank.

In a preferred embodiment, the means for removing the heavy solid waste fraction from the separation tank may be a heavy discharge conveyor, a part of which is positioned within the separation tank in alignment with the site of addition of waste into the tank, such that heavy solid waste falling under gravity substantially vertically towards the bottom of the tank below the site of addition is collected on the heavy discharge conveyor and conveyed out of the tank. In this embodiment the means for removing the light solid waste fraction from the separation tank may be a light discharge conveyor, a part of which is positioned within the separation tank spaced away from the site of addition of waste into the tank in the direction of the horizontal flow of liquid within the tank, such that light solid waste which is carried laterally by the flow of liquid within the tank away from the site of addition is collected on the light discharge conveyor and conveyed out of the tank.

The separator apparatus may further comprise an adjustable baffle plate positioned within the separation tank between the heavy discharge conveyor and the light discharge conveyor to separate material falling under gravity onto the heavy conveyor and material carried laterally onto the light conveyor.

Advantageously, the bag splitting apparatus of the invention and the wet separator apparatus of the invention may be used in combination in a waste processing system.

Accordingly, in a further aspect the invention provides a waste processing system for processing bagged solid waste comprising:

a bag splitting apparatus for splitting open bags containing solid waste comprising a rotatable flail structure having a plurality of flexible flails attached to a rotatable mounting, the flails being formed from a material having a Young's modulus of less than 50 GN/m² and a waste feed structure capable of receiving bagged solid waste and directing it towards the rotatable flail structure when the apparatus is in use; and

a wet separator apparatus for separating solid waste according to density comprising a separation tank containing a body of liquid, means for creating a horizontal flow within the liquid such that when solid waste is received in the body of liquid it is separated into a heavy solid waste fraction having a density above a certain threshold and light solid waste fraction having a density below the threshold, and means for separately removing the heavy and light solid waste fractions from the separation tank.

In the waste processing system of the invention the bag splitting apparatus is preferably positioned in close proximity to the surface of the liquid in the separation tank such that any refuse bags which are not split by a first pass through the bag splitter but which are retained floating on the surface of the liquid in the separation tank will be maintained in contact with the rotatable flail structure. In this manner the bag splitter apparatus and the wet separator apparatus function in combination to ensure that bags of refuse which are not fully split as they pass down the feed chute through the rotatable flail structure but which float on the surface of the separation tank are maintained in contact with the flails to provide a further opportunity for bag splitting to occur.

Various embodiments of the invention will now be described, by way of example only, with reference to the accompanying drawings in which:

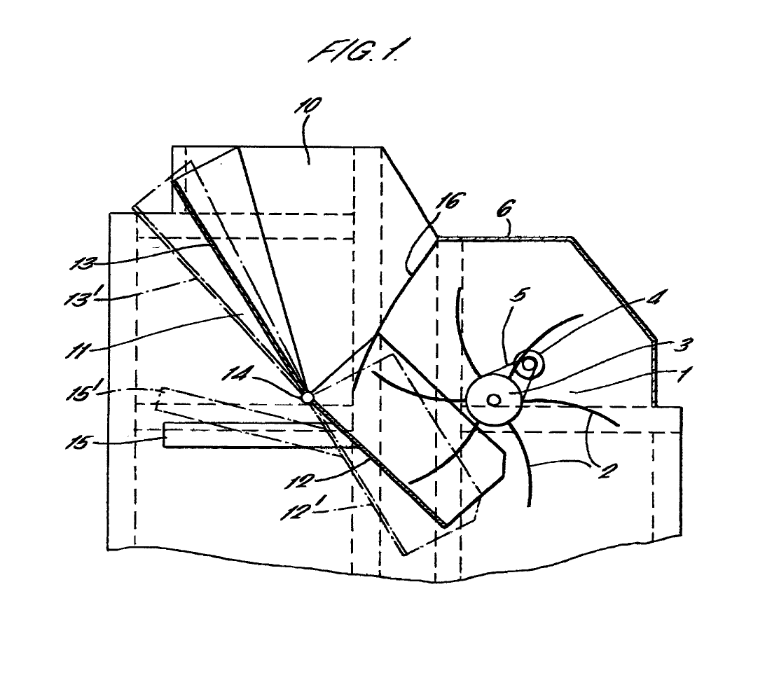

FIG. 1 shows a schematic representation of a bag splitting apparatus according to the invention

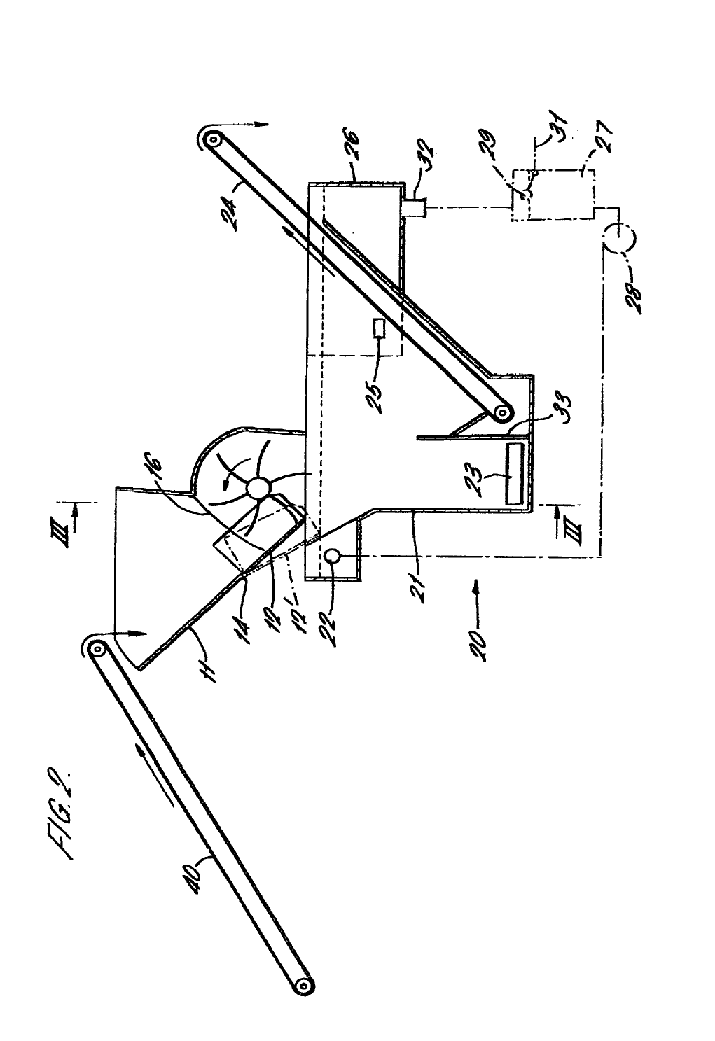

FIG. 2 shows a schematic sectional side elevation of a waste processing system comprising a bag splitting apparatus according to the invention and a wet separator apparatus according to the invention

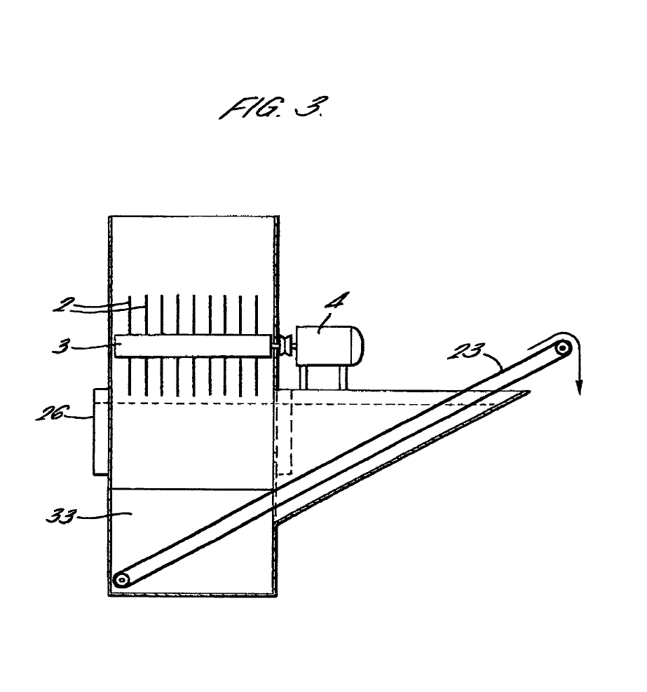

FIG. 3 shows a schematic section of the waste processing system of FIG. 2 in the direction of arrows III-III.

The embodiment of the bag splitter apparatus as shown in FIG. 1 comprises a rotatable flail structure 1 having a plurality of flails 2 attached to a rotatable mounting 3 which in this embodiment is a rotor arm driven by a flail drive motor 4 and drive belt 5. The flails are spaced apart along the length of the rotor arm, as illustrated in FIG. 3. The flails are formed of a strong yet highly flexible material, as described above. When the device is in use the rotor arm rotates at a speed of at least 150 rpm. This high speed of rotation results in a high peripheral speed of the flails and this, combined with the flexible nature of the material from which the flails are formed, generates a ‘soft’ cutting edge which is able to tear open plastic refuse bags and the like whilst minimising the risk of damage to the contents of the bags.

The bag splitting apparatus further includes a waste feed structure for receiving bagged solid waste. In the embodiment shown in FIG. 1 the waste feed structure is a feed chute comprising a top chute portion 11 and a bottom chute portion 12. The top chute portion has fixed sides 10 and an adjustable back plate 13 which is joined to the bottom chute portion 12 via a hinged joint 14. The hinged joint 14 permits independent movement of the entire bottom chute portion 12 relative to the top chute portion 11 and the back plate 13 of the top chute portion relative to the bottom chute portion 12.

In FIG. 1 the adjustable back plate of the top chute portion 13 is also shown in an extended position 13′.

A balance weight 15 is affixed to the bottom portion 11 of the feed chute and functions to retain the bottom portion of the chute at a pre-determined angle to the vertical. In the embodiment illustrated in FIG. 1 the balance weight 15 maintains the bottom portion 12 at an angle of approximately 45° to the vertical. This is merely illustrative and not intended to be limiting to the invention. The angle of the bottom chute portion to the vertical may be adjusted to control the speed at which bagged solid waste passes through the apparatus.

FIG. 1 also illustrates the bottom portion of the feed chute in a deflected position (12′, 15′) in which it is deflected away from the rotating fail structure 1. In FIG. 1 the bottom chute portion is shown in a deflected position at 60° to the vertical but this is intended to be merely illustrative rather than limiting to the invention. The application of pressure against the balance weight results in controlled deflection of the bottom chute portion, with the angle of deflection being directly proportional to the amount of pressure applied. The ability of the bottom chute portion to move away from the rotatable flail structure for example when a larger bulky item is encountered prevents jamming of the apparatus.

The rotatable flail structure may optionally be protected by a weighted flap 16 which is positioned to direct heavy items away from the flails thus preventing damage to the bag splitter.

The rotatable flail structure and the waste feed chute are both attached to a supporting framework, as shown in FIG. 1. The rotatable flail structure is covered by a removable outer cover 6.

FIG. 2 schematically illustrates the bag splitting apparatus in use in combination with a wet separator apparatus according to the invention 20. In the embodiment shown in FIG. 2, bagged solid waste is delivered to the feed chute of the bag splitting apparatus via a feed conveyor 40.

The wet separator apparatus 20 comprises a large separator tank 21 filled with liquid, usually water. Antimicrobial agents may be added to the liquid in order to prevent growth of bacteria. A horizontal flow of liquid within the tank is created in the direction indicated, i.e. away from the site of addition of waste to the tank. In order to create a horizontal cross-flow the separator comprises liquid inlets 22 positioned at the end of the tank at which the waste to be separated is added. At the other end of the tank, liquid flows out of outlets 25 in the side of the tank into an outlet box 26. Overflow from the tank 21 which occurs at the surface level of the liquid in the tank also discharges into the outlet box 26. Liquid from the outlet box 26 drains into pump box 27 and a constant return flow from the outlet box to the inlets is maintained by the action of a pump 28. The pump box is fitted with a ball valve controlling a liquid in-feed 31 to maintain a constant level of liquid within the pump box. The outflow from the outlet box to the pump box 32 may be fitted with a screen for the removal of fine material which may otherwise cause the pump to become blocked. In an alternative arrangement, the overflow from the outlet box 26 may discharge directly into the pump for re-circulation. In this arrangment the ball valve is fitted to the outlet box.

Waste material leaving the bag splitting apparatus falls into the separation tank. The heavy waste fraction above a certain density drops down towards the bottom of the tank immediately below the bag splitter and is collected on the heavy waste conveyor 23 and conveyed out of the tank. Light material above a certain density is carried laterally by the horizontal flow within the tank and is collected on a light waste conveyor 24 and conveyed out of the tank. An adjustable baffle plate 33 is provided between the heavy waste conveyor 23 and the light waste conveyor and functions to further separate the ‘heavies’ and ‘lights’ sections of the separator.

The depth of separator tank is determined by the time required to achieve effective separation of the light and heavy materials, with due consideration to the input velocity of the waste, the velocity of the cross-flow within the tank and the height of the baffle plate 33. In a typical embodiment the depth of the separation tank will be ˜7 ft.

FIG. 3 schematically illustrates a cross-section of the apparatus of FIG. 2 through the bag splitting apparatus. The heavy waste conveyor 23 is clearly shown as positioned directly beneath the rotatable flail structure when the bag splitting apparatus and wet separator are used in combination.

The use of separate heavy and light conveyors provides a simple and effective means for separately removing the heavy and light waste fractions from the separation tank. It also has the advantage that the two waste fractions are removed from the separation tank substantially intact. This may be important for the further processing of the waste fractions.

In the arrangement illustrated in FIGS. 2 and 3 the rotatable flail structure of the bag splitting apparatus is shown positioned close to the surface of the liquid within the separator tank. This is to ensure that any bags which are not fully split as they pass through the bag splitter but which remain floating on the surface of the separator tank remain in contact with the flails to provide an additional opportunity for effective splitting of the bags. This arrangement is very effective at splitting ‘bags-within-bags’ which are commonly encountered in household waste.

1. A bag splitting apparatus for use in splitting open bags containing solid waste, comprising:
a rotatable flail structure having a plurality of flexible flails attached to a rotatable mounting, the flails being formed from a material having a Young's modulus of less than 50GN m²; and
a waste feed guide structure capable of receiving bagged solid waste and directing it towards the rotatable flail structure when the apparatus is in use.

2. An apparatus as claimed in claim 1 wherein the flails are formed from a material having a Young's modulus of less than 20GN/m².

3. An apparatus as claimed in claim 2 wherein the flails are formed from a material having a Young's modulus of less than 10N/m².

4. An apparatus as claimed in claim 2 wherein the flails are formed from a material having a Young's modulus of less than 5gN/m².

5. An apparatus as claimed in claim 1 wherein the flails are formed from a plastics material.

6. An apparatus according to any one of claims 1 to 5 wherein the rotatable flail structure is adapted to rotate at at least 11 ms⁻¹ when the device is in use.

7. An apparatus according to any one of claims 1 to 6 wherein the waste feed guide structure comprises a feed chute having a top chute portion and a bottom chute portion, the bottom chute portion being attached to the top chute portion at a hinged joint to allow independent movement of the bottom chute portion relative to the top chute portion about the hinged joint, wherein the bottom chute portion is operable to direct bagged solid waste introduced into the feed chute towards the rotatable flail structure when the apparatus is in use.

8. An apparatus according to claim 7 which comprises a balance weight attached to the bottom chute portion to maintain the bottom chute portion at a pre-determined angle to the vertical whilst allowing deflection of the bottom chute portion away from the rotatable flail structure when a deflecting force is applied to the bottom chute portion.

9. An apparatus as claimed in claim 7 or claim 8 wherein the top chute portion comprises an adjustable back plate which is hinged to the bottom chute portion and capable of independent movement relative to the bottom chute portion about the hinge.

10. A wet separator apparatus adapted for use in separating solid waste according to density comprising:
a separation tank containing a body of liquid;
means for creating a horizontal flow within the liquid such that when solid waste is received in the body of liquid it is separated substantially into a heavy solid waste fraction having a density above a certain threshold and light solid waste fraction having a density below the threshold;
means for separately removing the heavy and light solid waste fractions from the separation tank.

11. A wet separator apparatus according to claim 10 wherein:
the means for removing the heavy solid waste fraction from the separation tank is a heavy discharge conveyor a part of which is positioned within the separation tank in alignment with the site of addition of waste into the tank, such that heavy solid waste falling under gravity substantially vertically towards the bottom of the tank below the site of addition is collected on the heavy discharge conveyor and conveyed out of the tank; and
the means for removing the light solid waste fraction from the separation tank is a light discharge conveyor a part of which is positioned within the separation tank spaced away from the site of addition of waste into the tank in the direction of the horizontal flow of liquid within the tank, such that light solid waste which is carried laterally by the flow of liquid within the tank away from the site of addition is collected on the light discharge conveyor and conveyed out of the tank.

12. An apparatus as claimed in claim 11 which comprises an adjustable baffle plate positioned within the separation tank between the heavy discharge conveyor and the light discharge conveyor to separate material falling under gravity onto the heavy conveyor and material carried laterally onto the light conveyor.

13. A waste processing system for processing bagged solid waste comprising:
a bag splitting apparatus for splitting open bags containing solid waste comprising a rotatable flail structure having a plurality of flexible flails attached to a rotatable mounting, the flails being formed from a material having a Young's modulus of less than 50GNm⁻² and a waste feed structure capable of receiving bagged solid waste and directing it towards the rotatable flail structure when the apparatus is in use; and
a wet separator apparatus for separating solid waste according to density comprising a separation tank containing a body of liquid, means for creating a horizontal flow within the liquid such that when solid waste is received in the body of liquid it is separated substantially into a heavy solid waste fraction having a density above a certain threshold and light solid waste fraction having a density below the threshold, and means for separately removing the heavy and light solid waste fractions from the separation tank.

14. A waste processing system according to claim 13 wherein the bag splitting apparatus is an apparatus according to any one of claims 2 to 9.

15. A waste processing system according to claim 13 or claim 14 wherein the wet separator apparatus is an apparatus according to any one of claims 10 to 12.

16. A waste processing system according to any one of claims 13 to 15 wherein the bag splitting apparatus is positioned in close proximity to the surface of the liquid in the separator tank such that any bags that are not split as they pass through the bag splitter apparatus but float on the surface of the liquid in the separator tank are maintained in contact with the rotatable flail structure.
